(19) United States
(12) Patent Application Publication
(10) Pub. No.: US 2023/0007146 A1
(43) Pub. Date: Jan. 5, 2023

(54) IMAGE PROCESSING DEVICE, IMAGE PROCESSING METHOD, AND PROGRAM

(71) Applicant: SONY SEMICONDUCTOR SOLUTIONS CORPORATION, KANAGAWA (JP)

(72) Inventors: HIROSUKE NAGANO, TOKYO (JP); SHIN YOSHIMURA, KANAGAWA (JP); ATSURO KOBAYASHI, KANAGAWA (JP)

(21) Appl. No.: 17/757,239

(22) PCT Filed: Dec. 4, 2020
(86) PCT No.: PCT/JP2020/045174

§ 371 Date: Jun. 13, 2022

(30) Foreign Application Priority Data
Dec. 19, 2019 (JP) 2019-229442

(51) Int. Cl. H04N 5/213; G06T 7/13

(52) U.S. Cl. CPC H04N 5/213; G06T 7/13

(57) ABSTRACT

The present technology relates to an image processing device, an image processing method, and a program that are able to effectively reduce noise. The image processing device according to the present technology includes a feedback rate setting section, a blending section, and a calculation section. The feedback rate setting section sets a feedback rate for pixels in a current line on the basis of a count that is set for pixels in a previous line. The current line and the previous line are among a plurality of lines forming an image. The pixels in the current line are to be subjected to a blending process of blending inputted pixels in the current line and already outputted pixels in the previous line. The blending section blends the pixels in the current line and the pixels in the previous line in accordance with the feedback rate. The calculation section calculates a count that is indicative of the cumulative number of pixels blended with the pixels in the current line by the blending process and is to be set for the pixels in the current line. The present technology is applicable to in-vehicle cameras.

### TECHNICAL FIELD

The present technology relates to an image processing device, an image processing method, and a program, and more particularly to an image processing device, an image processing method, and a program that are able to effectively reduce noise.

### BACKGROUND ART

Various technologies regarding image noise reduction have been proposed.

For example, a technology described in PTL 1 reduces noise by performing a smoothing process on image data without losing sharp edges through the use of a ε filter.

Further, a technology described in PTL 2 relates to 3DNR (3-Dimensional Noise Reduction) for reducing noise by mixing two consecutive two-dimensional frames on the time axis through the use of a small number of frame buffers.

### CITATION LIST

### Patent Literature

### [PTL 1]

Japanese Patent Laid-open No. 2004-172726

### [PTL 2]

PCT Patent Publication No. WO 2014/188799

### SUMMARY

### Technical Problems

Incidentally, in a case of eliminating low-frequency noise, the technology described in PTL 1 references a large number of pixels. Therefore, this technology requires the use of a line buffer with large capacity.

Similarly, the technology described in PTL 2 requires the use of a large-capacity buffer such as a frame buffer.

The present technology has been made in view of the above circumstances, and is able to reduce noise more effectively with limited hardware resources.

### Solution to Problems

According to an aspect of the present technology, there is provided an image processing device including a feedback rate setting section, a blending section, and a calculation section. The feedback rate setting section sets a feedback rate for pixels in a current line on the basis of a count that is set for pixels in a previous line. The current line and the previous line are among a plurality of lines forming an image. The pixels in the current line are to be subjected to a blending process of blending inputted pixels in the current line and already outputted pixels in the previous line. The blending section blends the pixels in the current line and the pixels in the previous line in accordance with the feedback rate. The calculation section calculates a count that is indicative of the cumulative number of pixels blended with the pixels in the current line by the blending process and is to be set for the pixels in the current line.

According to another aspect of the present technology, there is provided an image processing method for causing the image processing device to perform the steps of setting a feedback rate for pixels in a current line on the basis of a count that is set for pixels in a previous line, the current line and the previous line being among a plurality of lines forming an image, the pixels in the current line being to be subjected to a blending process of blending inputted pixels in the current line and already outputted pixels in the previous line, blending the pixels in the current line and the pixels in the previous line in accordance with the feedback rate, and calculating a count that is indicative of the cumulative number of pixels blended with the pixels in the current line by the blending process and is to be set for the pixels in the current line.

According to still another aspect of the present technology, there is provided a program for causing a computer to perform the processes of setting a feedback rate for pixels in a current line on the basis of a count that is set for pixels in a previous line, the current line and the previous line being among a plurality of lines forming an image, the pixels in the current line being to be subjected to a blending process of blending inputted pixels in the current line and already outputted pixels in the previous line, blending the pixels in the current line and the pixels in the previous line in accordance with the feedback rate, and calculating a count that is indicative of the cumulative number of pixels blended with the pixels in the current line by the blending process and is to be set for the pixels in the current line.

### BRIEF DESCRIPTION OF DRAWINGS

FIG. 1 is a block diagram illustrating an example configuration of an in-vehicle camera system according to an embodiment of the present technology.

FIG. 2 is a block diagram illustrating an example functional configuration of an image processing section.

FIG. 3 is a flowchart illustrating a noise reduction process of the image processing section.

FIG. 4 is a flowchart illustrating an output process that is performed in step S3 of FIG. 3.

FIG. 5 is a diagram illustrating an SNR improvement effect that is produced by a recursive 2DNR process without a fast convergence function.

FIG. 6 is a diagram illustrating an SNR improvement effect that is produced by the recursive 2DNR process with the fast convergence function.

FIG. 7 is a diagram illustrating an SNR improvement effect comparison between the recursive 2DNR process with the fast convergence function and the recursive 2DNR process without the fast convergence function.

FIG. 8 is a diagram illustrating an example of the SNR improvement effect that is produced by the recursive 2DNR process with the fast convergence function as compared with the recursive 2DNR process without the fast convergence function.

FIG. 9 is a diagram illustrating response characteristics in a situation where the strength of NR processing is low.

FIG. 10 is a diagram illustrating the response characteristics in a situation where the strength of NR processing is high.

FIG. 11 is a diagram illustrating an example functional configuration of the image processing section.

FIG. 12 is a block diagram illustrating an example hardware configuration of a computer.

FIG. 13 is a block diagram depicting an example of schematic configuration of a vehicle control system.

FIG. 14 is a diagram of assistance in explaining an example of installation positions of an outside-vehicle information detecting section and an imaging section.

### DESCRIPTION OF EMBODIMENT

An embodiment of the present technology will now be described. The description will be given in the following order.

1. Example Configuration of In-Vehicle Camera System

2. Operations of Image Processing Section

3. Effect of Recursive 2DNR Process with Fast Convergence Function

4. Modification of Image Processing Section

5. Other Modifications

### 1. Example Configuration of In-Vehicle Camera System

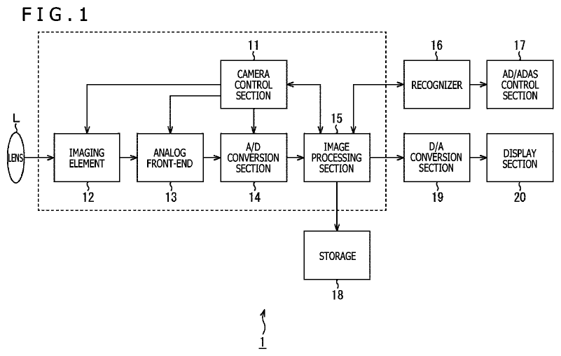

FIG. 1 is a block diagram illustrating an example configuration of an in-vehicle camera system 1 according to an embodiment of the present technology.

The in-vehicle camera system 1 depicted in FIG. 1 is used by an in-vehicle camera that is utilized for an autonomous or advanced driving system. The in-vehicle camera system 1 is a system that captures a video image of the surroundings of an automobile and performs a noise reduction (NR) process on the captured video image.

As depicted in FIG. 1, the in-vehicle camera system 1 includes a lens L, a camera control section 11, an imaging element 12, an analog front-end 13, an A/D conversion section 14, an image processing section 15, a recognizer 16, an AD/ADAS control section 17, a storage 18, a D/A conversion section 19, and a display section 20.

The lens L captures incident light from an object, guides the incident light to the imaging element 12, and forms an image of the object on a light-receiving surface of the imaging element 12.

The camera control section 11 controls the operations of the imaging element 12, the analog front-end 13, the A/D conversion section 14, and the image processing section 15. For example, the camera control section 11 controls the operations of the individual components so as to perform a better imaging operation by using the result of NR processing performed by the image processing section 15.

The imaging element 12 includes, for example, a CCD (Charge Coupled Device) image sensor or a CMOS (Complementary Metal Oxide Semiconductor) image sensor. Electrons are accumulated in individual pixels of the imaging element 12 for a predetermined period according to the image of the object that is formed on the light-receiving surface through the lens L. Signals corresponding to the electrons accumulated in the individual pixels are supplied to the analog front-end 13.

The analog front-end 13 performs an analog process such as a process of amplifying the signals supplied from the imaging element 12. The signals subjected to the analog process are supplied to the A/D conversion section 14.

The A/D conversion section 14 receives the signals supplied from the analog front-end 13, and converts the received signals to digital image data. The digital image data is supplied to the image processing section 15.

The image processing section 15 performs a recursive 2DNR (2-Dimensional Noise Reduction) process with a later-described fast convergence function on the digital image data supplied from the A/D conversion section 14. After being subjected to the recursive 2DNR process, the digital image data is supplied to the camera control section 11, the recognizer 16, the storage 18, and the D/A conversion section 19.

For application to an autonomous or advanced driving system, the digital image data subjected to the recursive 2DNR process is supplied to the recognizer 16. For application to a dashboard camera, the digital image data subjected to the recursive 2DNR process is supplied to the storage 18. For application to a smart display or a rear-vision display, the digital image data subjected to the recursive 2DNR process is supplied to the D/A conversion section 19.

The recognizer 16 includes, for example, a DMS (Drive Monitoring System). On the basis of the digital image data supplied from the image processing section 15, the recognizer 16 recognizes, for example, automobiles, persons, signs, traffic lights, and white lines around an automobile in which the in-vehicle camera system 1 is mounted. The recognizer 16 supplies the result of recognition to the AD/ADAS control section 17.

The AD/ADAS control section 17 is a component for implementing autonomous driving (AD) of an automobile in which the in-vehicle camera system 1 is mounted or implementing an advanced driver-assistance system (ADAS). On the basis of the result of recognition supplied from the recognizer 16, the AD/ADAS control section 17 controls the driving of the automobile.

The storage 18 includes an auxiliary storage device such as a semiconductor memory, a HDD (Hard Disk Drive), or other internal or external storage. The storage 18 stores the digital image data supplied from the image processing section 15.

The D/A conversion section 19 receives the digital image data from the image processing section 15, and converts the received digital image data to an analog signal. The resulting analog signal is supplied to the display section 20.

The display section 20 includes, for example, a display or what is called a smart rear-view mirror. On the basis of the analog signal supplied from the D/A conversion section 19, the display section 20 displays a video image.

For example, the in-vehicle camera system 1 may be configured such that the camera control section 11, the imaging element 12, the analog front-end 13, the A/D conversion section 14, and the image processing section 15, which are enclosed by a broken line in FIG. 1, are built in a single sensor chip. Further, the recognizer 16 may also be built in the same sensor chip in addition to the components enclosed by the broken line.

Alternatively, the in-vehicle camera system 1 may be configured such that the camera control section 11, the imaging element 12, the analog front-end 13, and the A/D conversion section 14 are built in a single sensor chip while the image processing section 15 is built in an independent chip.

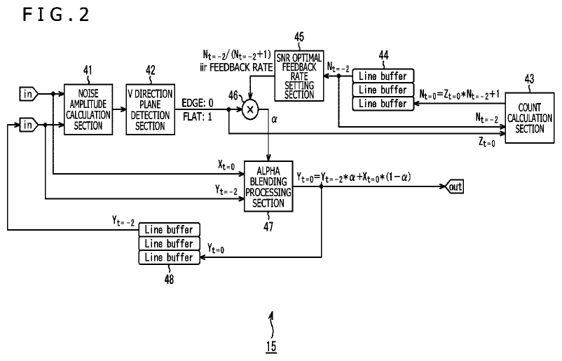

FIG. 2 is a block diagram illustrating an example functional configuration of the image processing section 15.

As depicted in FIG. 2, the image processing section 15 includes a noise amplitude calculation section 41, a V direction plane detection section 42, a count calculation section 43, a line buffer section 44, a SNR (Signal-to-Noise Ratio) optimal feedback rate setting section 45, a multiplication section 46, an alpha blending processing section 47, and a line buffer section 48.

The image processing section 15 is a vertical direction recursive 2DNR circuit suitable for a RAW image in which same-color pixels exist at intervals of two lines like a Bayer pixel arrangement.

The digital image data regarding individual lines forming an image acquired by the imaging element 12 is supplied from the A/D conversion section 14 to the image processing section 15. The image processing section 15 sequentially performs the recursive 2DNR process with the fast convergence function on the line-specific digital image data in the order in which the line-specific digital image data is supplied from the A/D conversion section 14. The description given with reference to FIGS. 2 to 4 relates to the recursive 2DNR process that is performed on a pixel value Xₜ₌₀ of one of a plurality of pixels included in a current line in a situation where a line supplied from the A/D conversion section 14 to the image processing section 15 is regarded as the current line to be processed. The recursive 2DNR process performed on one line of pixels by the image processing section 15 is similar to the recursive 2DNR process performed on the pixel value Xₜ₌₀ of the above-mentioned one pixel.

As depicted in FIG. 2, the pixel value Xₜ₌₀ of pixels in the current line is inputted to the noise amplitude calculation section 41 and the alpha blending processing section 47. Further, the line buffer section 48, which is capable of retaining three lines of pixel values, inputs an NR pixel value Yₜ₌₋₂ to the noise amplitude calculation section 41 and the alpha blending processing section 47. Here, an NR pixel value Yₜ₌₀ is a pixel value that is obtained when NR processing is performed on the pixel value Xₜ₌₀ of pixels in the current line, and the NR pixel value Yₜ₌₋₂ is the pixel value of pixels in a second preceding line, which corresponds to the NR pixel value Yₜ₌₀. That is, the NR pixel value Yₜ₌₋₂ is a pixel value obtained when NR processing is performed on a pixel that is included in the second line preceding the current line and positioned vertically with respect to a pixel having the pixel value Xₜ₌₀. It should be noted that subscripts included in the pixel value Xₜ₌₀ and the NR pixel value Yₜ₌₀ indicate the number of lines relative to the current line.

On the basis of the pixel value Xₜ₌₀ and the NR pixel value Yₜ₌₋₂, the noise amplitude calculation section 41 calculates the noise amplitude of shot noise in photoelectric conversion for each of a plurality of pixels included in the current line. The noise amplitude calculation section 41 supplies information indicating the noise amplitude of each of the plurality of pixels included in the current line to the V direction plane detection section 42 together with the pixel value Xₜ₌₀ and the NR pixel value Yₜ₌₋₂.

The V direction plane detection section 42 performs a detection operation on the basis of the pixel value Xₜ₌₀ and the NR pixel value Yₜ₌₋₂, which are supplied from the noise amplitude calculation section 41, and detects an edge appearing vertically with respect to the current line. More specifically, in a case where the difference between the pixel value Xₜ₌₀ and the NR pixel value Yₜ₌₋₂ of a pixel is greater than the noise amplitude calculated by the noise amplitude calculation section 41, the V direction plane detection section 42 detects an edge of the pixel. Meanwhile, in a case where the difference is smaller than the noise amplitude, the V direction plane detection section 42 does not detect an edge of the pixel, and in this case, the pixel is flat as viewed vertically with respect to the current line.

The V direction plane detection section 42 sets an edge determination result Zₜ₌₀ of each of the plurality of pixels included in the current line for all the pixels included in the current line. For example, the V direction plane detection section 42 sets the edge determination result Zₜ₌₀ to 0 for a pixel whose edge is detected, and sets the edge determination result Zₜ₌₀ to 1 for a pixel whose edge is not detected. Then, the edge determination result Zₜ₌₀ set to 0 or 1 for each pixel in the current line is supplied to the count calculation section 43 and the multiplication section 46.

On the basis of the edge determination result Zₜ₌₀ of each of the plurality of pixels included in the current line, which is supplied from the V direction plane detection section 42, and on the count Nₜ₌₋₂ of each pixel in the second preceding line, which is acquired from the line buffer section 44, the count calculation section 43 calculates the count Nₜ₌₀ of each of the plurality of pixels included in the current line.

More specifically, the count calculation section 43 calculates the count Nₜ₌₀ of each of the plurality of pixels included in the current line by multiplying the edge determination result Zₜ₌₀ of each of the plurality of pixels included in the current line by the count Nₜ₌₋₂ of each pixel in the second preceding line and adding 1 to the result of the multiplication. That is, the count Nₜ₌₀ of a pixel is expressed by Equation (1) below.

[Math. 1]

Nₜ₌₀=Zₜ₌₀×Nₜ₌₋₂+1 (1)

In the recursive 2DNR process, the pixel value Xₜ₌₀ of pixels in the current line and the NR pixel value Yₜ₌₀ of pixels in the second preceding line are mixed (blended). As a result, noise is reduced comparably to a case where the pixel values of a wide range of pixels are mixed. That is, the use of a recursive filter makes it possible to consider that a wide range of noise reduction results derived from processing of up to the current line are degenerated to the pixel values of individual pixels included in the current line. Therefore, the count Nₜ₌₀ is a value indicating the cumulative number of pixels (the range of processed pixels including up to the ones in the current line) mixed with the pixel values of individual pixels included in the current line.

The count calculation section 43 supplies the count Nₜ₌₀ of each of the plurality of pixels included in the current line to the line buffer section 44.

The line buffer section 44 includes line buffers for three lines. Each of the line buffers included in the line buffer section 44 stores the count of one line of pixels. That is, the line buffer section 44 stores the count Nₜ₌₋₂ of each pixel in the second line preceding the current line, the count Nₜ₌₋₁ of each pixel in the first line preceding the current line, and the count Nₜ₌₀ of each pixel in the current line on an individual line basis.

An SNR optimal feedback rate setting section 45 acquires, from the line buffer section 44, the count Nₜ₌₋₂ of each of the plurality of pixels included in the current line, which corresponds to the individual pixels in the second preceding line. Then, on the basis of the count Nₜ₌₋₂ of pixels in the second preceding line, the SNR optimal feedback rate setting section 45 sets an iir (Infinite Impulse Response) feedback rate for each of the plurality of pixels included in the current line. More specifically, as indicated in Equation (2) below, the SNR optimal feedback rate setting section 45 adds 1 to the count Nₜ₌₋₂ of pixels in the second preceding line, divides the count Nₜ₌₋₂ of pixels in the second preceding line by the result of the addition, and sets the result of the division as the iir feedback rate.

[Math. 2]

iir feedback rate=Nₜ₌₋₂/Nₜ₌₋₂+1 (2)

The SNR optimal feedback rate setting section 45 supplies, to the multiplication section 46, information indicative of the iir feedback rate set for each of the plurality of pixels included in the current line.

The multiplication section 46 multiplies the edge determination result Zₜ₌₀ of each of the plurality of pixels included in the current line, which is supplied from the V direction plane detection section 42, by the iir feedback rate for each pixel, which is supplied from the SNR optimal feedback rate setting section 45. Accordingly, the multiplication section 46 calculates a mixing ratio α for each of the plurality of pixels included in the current line, and supplies the calculated mixing ratio α to the alpha blending processing section 47.

The alpha blending processing section 47 performs an alpha blending process on each of the plurality of pixels included in the current line in order to mix the pixel value Xₜ₌₀ and the NR pixel value Yₜ₌₋₂ at the mixing ratio α for each pixel, which is supplied from the multiplication section 46.

More specifically, the alpha blending processing section 47 adds the result of multiplication of the pixel value Xₜ₌₀ by (1−α) to the result of multiplication of the NR pixel value Yₜ₌₋₂ by α, and outputs the result of the addition to a subsequent stage as the NR pixel value Yₜ₌₀. The alpha blending process performed by the alpha blending processing section 47 is expressed by Equation (3) below.

[Math. 3]

Yₜ₌₀=Yₜ₌₋₂×α+Xₜ₌₀×(1−α) (3)

As mentioned earlier, for a pixel whose edge is detected, the V direction plane detection section 42 sets the edge determination result Zₜ₌₀ to 0. Therefore, the multiplication section 46 calculates that the mixing ratio α is 0 (=edge determination result Zₜ₌₀×iir feedback rate). Consequently, for the pixel whose edge is detected, the alpha blending processing section 47 adds the result of multiplication of the pixel value Xₜ₌₀ by 1 (=1−α) to the result of multiplication of the NR pixel value Yₜ₌₋₂ by 0 (=α).

Meanwhile, for a pixel whose edge is not detected, the V direction plane detection section 42 sets the edge determination result Zₜ₌₀ to 1. Therefore, the multiplication section 46 calculates that the mixing ratio α is the iir feedback rate (=edge determination result Zₜ₌₀×iir feedback rate). Consequently, for the pixel whose edge is not detected, the alpha blending processing section 47 adds the result of multiplication of the pixel value Xₜ₌₀ by 1/(Nₜ₌₋₂+1) (=1−α) to the result of multiplication of the NR pixel value Yₜ₌₋₂ by Nₜ₌₋₂/(Nₜ₌₋₂+1) (=α).

The NR pixel value Yₜ₌₀ outputted from the alpha blending processing section 47 is not only supplied to the outside of the image processing section 15, but also supplied to the line buffer section 48. In this instance, the NR pixel value Yₜ₌₀ derived from a horizontal smoothing process performed on the current line can be supplied to the outside of the image processing section 15.

The line buffer section 48 includes line buffers for three lines. Each of the line buffers included in the line buffer section 48 stores the NR pixel value of one line of pixels. That is, the line buffer section 48 stores the NR pixel value Yₜ₌₋₂ of each pixel in the second line preceding the current line, the NR pixel value Yₜ₌₋₁ of each pixel in the first line preceding the current line, and the NR pixel value Yₜ₌₀ of each pixel in the current line on an individual line basis.

As described above, according to the edge determination result, the image processing section 15 resets the count Nₜ₌₀ to 1 for a pixel whose edge is detected, and increments the count Nₜ₌₀ for a pixel whose edge is not detected. Further, the image processing section 15 determines the iir feedback rate on the basis of the count Nₜ₌₋₂. Therefore, the iir feedback rate for a pixel whose edge is detected can be determined without being affected by a wide range of noise reduction results derived from processing of up to the current line. This enables the image processing section 15 to set the iir feedback rate for each pixel so as to be able to perform optimal NR processing with respect to SNR depending on whether or not an edge is detected.

Accordingly, the image processing section 15 is able to provide convergence such that the influence of SNR upon a pixel whose edge is detected rapidly goes into a steady state. Therefore, the function of setting the iir feedback rate for making it possible to perform optimal NR processing with respect to SNR, which is implemented by the count calculation section 43 and the SNR optimal feedback rate setting section 45, is referred to as the fast convergence function.

Further, the image processing section 15 is able to perform NR processing by using the line buffer sections 44 and 48, which have a smaller capacity than a large-capacity buffer such as a frame buffer, and reduce noise more effectively with limited hardware resources.

### 2. Operations of Image Processing Section

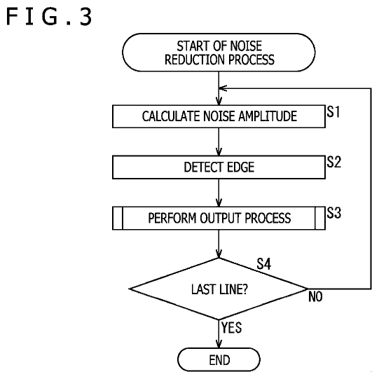

A noise reduction process of the image processing section 15 having the above-described configuration will now be described with reference to the flowchart of FIG. 3.

The noise reduction process depicted in FIG. 3 starts when the current line is supplied from the A/D conversion section 14 to the image processing section 15.

In step S1, the noise amplitude calculation section 41 calculates the noise amplitude of each pixel in accordance with the pixel value Xₜ₌₀ of the plurality of pixels included in the current line and with the NR pixel value Yₜ₌₋₂ corresponding to each of the pixels.

In step S2, on the basis of the pixel value Xₜ₌₀, the NR pixel value Yₜ₌₋₂ and the noise amplitude, the V direction plane detection section 42 detects an edge of each of the plurality of pixels included in the current line that appears vertically with respect to the current line. For example, in a case where the difference between the pixel value Xₜ₌₀ and the NR pixel value Yₜ₌₋₂ of a pixel is equal to or greater than the noise amplitude calculated in step S1, the V direction plane detection section 42 detects an edge of the pixel.

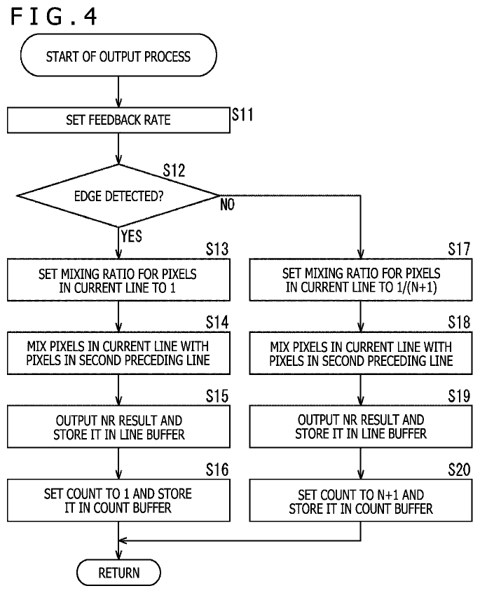

In step S3, the image processing section 15 performs an output process. The output process is performed to output the NR pixel value Yₜ₌₀ that is derived from NR processing performed on the pixel value Xₜ₌₀ of the plurality of pixels included in the current line. The output process will be described later with reference to the flowchart of FIG. 4.

In step S4, the image processing section 15 determines whether or not the current line is the last line forming an acquired captured image. In a case where it is determined that the current line is not the last line, the image processing section 15 repeats processes of step S1 and the subsequent steps.

Meanwhile, in a case where it is determined that the current line is the last line, the process terminates.

The output process performed in step S3 of FIG. 3 will now be described with reference to the flowchart of FIG. 4.

In step S11, on the basis of the count Nₜ₌₋₂ of each pixel in the second preceding line, which is acquired from the line buffer section 44, the SNR optimal feedback rate setting section 45 sets the iir feedback rate for each of the plurality of pixels included in the current line.

In step S12, in a case where a determination is made on the basis of the result of detection in step S2 of FIG. 3 and an edge of a determination target pixel is detected, processing proceeds to step S13. In this case, for the determination target pixel, the V direction plane detection section 42 sets the edge determination result Zₜ₌₀ to 0.

In step S13, the multiplication section 46 calculates the mixing ratio α by multiplying the edge determination result Zₜ₌₀ of each of the plurality of pixels included in the current line by the iir feedback rate for each pixel. For a pixel targeted for processing in step S13, the mixing ratio α is 0 because the edge determination result Zₜ₌₀ is set to 0 according to the result of determination in step S12. In this case, therefore, the ratio (1−α) of mixing the pixel value Xₜ₌₀ is 1. The multiplication section 46 supplies the mixing ratio α to the alpha blending processing section 47, and the alpha blending processing section 47 sets 1 as the ratio (1−α) of mixing the pixel value Xₜ₌₀ of pixels in the current line.

In step S14, the alpha blending processing section 47 generates the NR pixel value Yₜ₌₀ by mixing the pixel value Xₜ₌₀ of pixels in the current line with the NR pixel value Yₜ₌₋₂ of pixels in the second preceding line at the mixing ratio α calculated in step S13 by the multiplication section 46.

In step S15, the alpha blending processing section 47 not only outputs the NR pixel value Yₜ₌₀, which represents a noise reduction result generated in step S14, to a subsequent stage, but also causes the line buffer section 48 to store the NR pixel value Yₜ₌₀.

In step S16, on the basis of the edge determination result Zₜ₌₀, the count calculation section 43 sets 1 as the count Nₜ₌₀ of a currently processed pixel, and causes the line buffer section 44 for the count to store the count Nₜ₌₀.

Meanwhile, in a case where an edge of the determination target pixel is not detected in step S12, processing proceeds to step S17. In this case, for the determination target pixel, the V direction plane detection section 42 sets the edge determination result Zₜ₌₀ to 1.

In step S17, the multiplication section 46 calculates the mixing ratio α by multiplying the edge determination result Zₜ₌₀ of each of the plurality of pixels included in the current line by the iir feedback rate for each pixel. For a pixel targeted for processing in step S17, the mixing ratio α is Nₜ₌₋₂/(Nₜ₌₋₂+1) because the edge determination result Zₜ₌₀ is set to 1 according to the result of determination in step S12. In this case, therefore, the ratio (1−α) of mixing the pixel value Xₜ₌₀ is 1/(Nₜ₌₋₂+1). The multiplication section 46 supplies the mixing ratio α to the alpha blending processing section 47, and the alpha blending processing section 47 sets 1/(Nₜ₌₋₂+1) as the ratio (1−α) of mixing the pixel value Xₜ₌₀ of pixels in the current line.

In step S18, the alpha blending processing section 47 generates the NR pixel value Yₜ₌₀ by mixing the pixel value Xₜ₌₀ of pixels in the current line with the NR pixel value Yₜ₌₋₂ of pixels in the second preceding line at the mixing ratio α calculated in step S17 by the multiplication section 46.

In step S19, the alpha blending processing section 47 not only outputs the NR pixel value Yₜ₌₀, which represents a noise reduction result generated in step S18, to a subsequent stage, but also causes the line buffer section 48 to store the NR pixel value Yₜ₌₀.

In step S20, on the basis of the edge determination result Zₜ₌₀, the count calculation section 43 sets (Nₜ₌₋₂+1) as the count Nₜ₌₀ of a currently processed pixel, and causes the line buffer section 44 for the count to store the count Nₜ₌₀. It should be noted that step S12 and steps S13 to S16 or steps S17 to S20 are performed on each of one line of pixels, as is the case with the pixel value Xₜ₌₀. After a series of processing steps is performed on each of one line of pixels, processing returns to step S3 of FIG. 3, and processes of step S3 and the subsequent steps are performed.

### 3. Effect of Recursive 2DNR Process with Fast Convergence Function

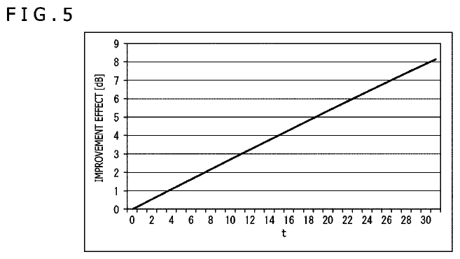

An effect produced by the recursive 2DNR process with the fast convergence function will now be described with reference to FIGS. 5 to 10. Here, it is assumed that the recursive 2DNR process is performed on an image structured to have flatness below an edge in a case of being viewed vertically.

The above-mentioned recursive 2DNR process of mixing the pixel value Xₜ₌₀ (the pixel value of pixels in the current line) with the NR pixel value Yₜ₌₋₂ (the pixel value of pixels in a previous line) at the mixing ratio α calculated by multiplying the edge determination result of each pixel in the current line with the iir feedback rate set for each pixel in the current line on the basis of the count of each pixel in the second preceding line is called the recursive 2DNR process with the fast convergence function. In the recursive 2DNR process with the fast convergence function, an appropriate iir feedback rate is set for each pixel.

Meanwhile, the recursive 2DNR process of mixing the pixel value Xₜ₌₀ (the pixel value of pixels in the current line) with the NR pixel value Yₜ₌₋₂ (the pixel value of pixels in a previous line) in accordance with the iir feedback rate set by using the certainty of the edge determination result is called the recursive 2DNR process without the fast convergence function. In the recursive 2DNR process without the fast convergence function, an appropriate iir feedback rate might not be set for each pixel.

First of all, a case where the recursive 2DNR process without the fast convergence function is performed on a processing target image will be described.

An effect of improving the current line SNR of a processing target that is produced by the recursive 2DNR process without the fast convergence function is expressed, for example, by Equation (4) below.

$$\begin{matrix}[ Math . 4 ] & \\ Improvement effect [ dB ] = - 20 \times {log}_{10} ( \frac{1}{{Std}_{c ( t = 1 )}} ) + 20 \times {log}_{10} ( \frac{1}{\sqrt{{{Std}_{c ( t = 1 )}^{2}}_{} \times {( \frac{1}{32} )}^{2} + {Std}_{p ( t = 1 )}^{2} \times {( \frac{31}{32} )}^{2}}} ) & ( 4 )\end{matrix}$$

Std_{c} in Equation (4) represents the standard deviation of difference between individual pixels in a processing target current line with noise and individual pixels in an ideal current line without noise. Further, Stdₚ in Equation (4) represents the standard deviation of difference between individual pixels in a processed previous line and individual pixels in an ideal previous line without noise.

In a case where the recursive 2DNR process without the fast convergence function is performed, a plurality of pixels included in the current line in a case of t=0 is directly buffered. Therefore, the standard deviation Stdₚ₍ₜ₌₁₎ is equal to Std_{c(t=0)} as indicated in Equation (5) below.

[Math. 5]

Stdₚ₍ₜ₌₁₎=Std_{c(t=0)} (5)

Further, the standard deviation Stdₚ₍ₜ₌ₓ₎ of each pixel in the current line in a case of t=x remains constant. Thus, it can be assumed that Equation (6) below is established.

[Math. 6]

Std_{c}=Std_{c(t=0)}Std_{c(t=1)}=Std_{c(t=2)}=Std_{c(t=3)}=Std_{c(t=4)} . . . Std_{c(t=x)} (6)

When Equation (4) is transformed by using Equations (5) and (6), Equation (7) below is obtained.

$$\begin{matrix}[ Math . 7 ] & \\ Improvement effect [ dB ] = - 20 \times {log}_{10} ( \frac{1}{{Std}_{c}} ) + 20 \times {log}_{10} ( \frac{1}{\sqrt{{{Std}_{c}^{2}}_{} \times {( \frac{1}{32} )}^{2} + {Std}_{c}^{2} \times {( \frac{31}{32} )}^{2}}} ) \approx 0.27 [ dB ] & ( 7 )\end{matrix}$$

As indicated in Equation (7), in a case of t=1, an expected value of an SNR improvement effect produced by the recursive 2DNR process without the fast convergence function is approximately 0.27 [dB].

Meanwhile, the SNR improvement effect produced by the recursive 2DNR process with the fast convergence function is expressed by Equation (8) below.

$$\begin{matrix}[ Math . 8 ] & ( 8 ) \\ I mprovement effect [ dB ] = - 20 \times {log}_{10} ( \frac{1}{{Std}_{c}} ) + 20 \times {log}_{10} ( \frac{1}{\sqrt{{{Std}_{c}^{2}}_{} \times {( \frac{1}{2} )}^{2} + {Std}_{c}^{2} \times {( \frac{1}{2} )}^{2}}} ) \approx 3.01 [ dB ] & \end{matrix}$$

As indicated in Equation (8), in a case of t=1, the SNR improvement effect produced by the recursive 2DNR process with the fast convergence function is approximately 3.01 [dB]. That is, in a case of t=1, the recursive 2DNR process with the fast convergence function produces an improvement effect of approximately 2.74 [dB] as compared with the recursive 2DNR process without the fast convergence function.

The improvement effect of t=2 or later will now be described. In recursive 2DNR, a line sent to a line below after being subjected to 2DNR processing is the same as a line that is used in the next line as a previous line. Therefore, the standard deviation Stdₚ₍ₜ₌ₓ₊₁₎ of each pixel in a previous line in the recursive 2DNR process without the fast convergence function in a case of t=x+1 is expressed by Equation (9) below.

$$\begin{matrix}[ Math . 9 ] & \\ {Std}_{p ( t = x + 1 )} = \sqrt{{Std}_{c ( t = x )}^{2} \times {( \frac{1}{32} )}^{2} + {Std}_{p ( t = x )}^{2} \times {( \frac{31}{32} )}^{2}} & ( 9 )\end{matrix}$$

The NR pixel value of each pixel in the current line that is stored in a line buffer in a case of t=2 is read as the NR pixel value of each pixel in a previous line in a case of t=3. Therefore, the standard deviation of the NR pixel value in a case of t=2 is equal to Stdₚ₍ₜ₌₃₎. Consequently, the standard deviation Stdₚ₍ₜ₌₃₎ of each pixel in a previous line in a case of t=3 is expressed by Equation (10) below by using Equation (9).

$$\begin{matrix}[ Math . 10 ] & \\ \begin{matrix}{Std}_{p ( t = 3 )} = \sqrt{{Std}_{c ( t = 2 )}^{2} \times {( \frac{1}{32} )}^{2} + {Std}_{p ( t = 2 )}^{2} \times {( \frac{31}{32} )}^{2}} \\ = \sqrt{{Std}_{c ( t = 2 )}^{2} \times {( \frac{1}{32} )}^{2} + ( {Std}_{c ( t = 1 )}^{2} \times {( \frac{1}{32} )}^{2} + {Std}_{p ( t = 1 )}^{2} \times {( \frac{31}{32} )}^{2} ) \times {( \frac{31}{32} )}^{2}} \\ = \sqrt{{Std}_{c}^{2} \times {( \frac{1}{32} )}^{2} + ( {Std}_{c}^{2} \times {( \frac{1}{32} )}^{2} + {Std}_{c}^{2} \times {( \frac{31}{32} )}^{2} ) \times {( \frac{31}{32} )}^{2}} \\ = \sqrt{{( \frac{1}{32} )}^{2} + ( {( \frac{1}{32} )}^{2} + {( \frac{31}{32} )}^{2} ) \times {( \frac{31}{32} )}^{2} + {Std}_{c}}\end{matrix} & ( 10 )\end{matrix}$$

In a case of t=2, the SNR improvement effect produced by the recursive 2DNR process without the fast convergence function is expressed by Equation (11) below by using Equation (10).

$$\begin{matrix}[ Math . 11 ] & \\ Improvement effect [ dB ] = 20 \times {log}_{10} ( \frac{1}{\sqrt{{( \frac{1}{32} )}^{2} + ( {( \frac{1}{32} )}^{2} + {( \frac{31}{32} )}^{2} ) \times {( \frac{31}{32} )}^{2}}} ) \approx 0.54 [ dB ] & ( 11 )\end{matrix}$$

Similarly, in a case of t=3, the SNR improvement effect produced by the recursive 2DNR process without the fast convergence function is expressed by Equation (12) below.

$$\begin{matrix}[ Math . 12 ] & \\ Improvement effect [ dB ] = 20 \times {log}_{10} \\ ( \frac{1}{\sqrt{{( \frac{1}{32} )}^{2} + ( {( \frac{1}{32} )}^{2} + ( {( \frac{1}{32} )}^{2} + {( \frac{31}{32} )}^{2} ) \times {( \frac{31}{32} )}^{2} ) \times {( \frac{31}{32} )}^{2}}} ) \approx 0.81 [ dB ] & ( 12 )\end{matrix}$$

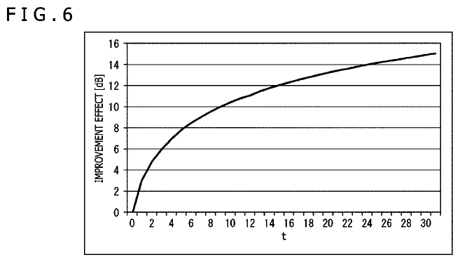

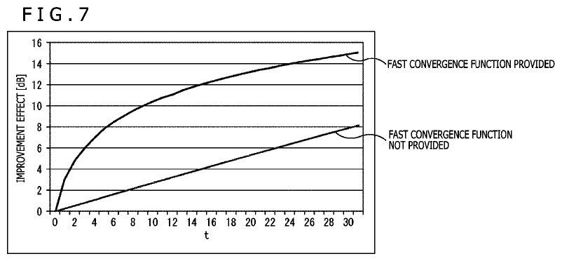

Accordingly, in a case of t=0 to 31, the SNR improvement effect produced by the recursive 2DNR process without the fast convergence function is determined as depicted in FIG. 5. In FIG. 5, the horizontal axis represents t, and the vertical axis represents the SNR improvement effect. The similar representation applies also to FIGS. 6 and 7, which will be referenced later.

Meanwhile, the standard deviation Stdₚ₍ₜ₌ₓ₊₁₎ of each pixel in a previous line in the recursive 2DNR process with the fast convergence function in a case of t=x+1 is expressed by Equation (13) below.

$$\begin{matrix}[ Math . 13 ] & \\ {Std}_{p ( t = x + 1 )} = \sqrt{{Std}_{c ( t = x )}^{2} \times {( \frac{1}{x + 1} )}^{2} + {Std}_{p ( t = x )}^{2} \times {( \frac{x}{x + 1} )}^{2}} & ( 13 )\end{matrix}$$

The standard deviation Stdₚ₍ₜ₌₃₎ of each pixel in a previous line in a case of t=3, which is equal to the standard deviation of the NR pixel value in a case of t=2, is expressed by Equation (14) below by using Equation (13).

$$\begin{matrix}[ Math . 14 ] & \\ \begin{matrix}{Std}_{p ( t = 3 )} = \sqrt{{Std}_{c ( t = 2 )}^{2} \times {( \frac{1}{3} )}^{2} + {Std}_{p ( t = 2 )}^{2} \times {( \frac{2}{3} )}^{2}} \\ = \sqrt{{Std}_{c ( t = 2 )}^{2} \times {( \frac{1}{3} )}^{2} + ( {Std}_{c ( t = 1 )}^{2} \times {( \frac{1}{2} )}^{2} + {Std}_{p ( t = 1 )}^{2} \times {( \frac{1}{2} )}^{2} ) \times {( \frac{2}{3} )}^{2}} \\ = \sqrt{{Std}_{c}^{2} \times {( \frac{1}{3} )}^{2} + ( {Std}_{c}^{2} \times {( \frac{1}{2} )}^{2} + {Std}_{c}^{2} \times {( \frac{1}{2} )}^{2} ) \times {( \frac{2}{3} )}^{2}} \\ = \sqrt{{( \frac{1}{3} )}^{2} + ( {( \frac{1}{2} )}^{2} + {( \frac{1}{2} )}^{2} ) \times {( \frac{2}{3} )}^{2} + {Std}_{c}}\end{matrix} & ( 14 )\end{matrix}$$

In a case of t=2, the SNR improvement effect produced by the recursive 2DNR process with the fast convergence function is expressed by Equation (15) below by using Equation (14).

$$\begin{matrix}[ Math . 15 ] & \\ Improvement effect [ dB ] = 20 \times {log}_{10} ( \frac{1}{\sqrt{{( \frac{1}{3} )}^{2} + ( {( \frac{1}{2} )}^{2} + {( \frac{1}{2} )}^{2} ) \times {( \frac{2}{3} )}^{2}}} ) \approx 4.77 [ dB ] & ( 15 )\end{matrix}$$

Similarly, in a case of t=3, the SNR improvement effect produced by the recursive 2DNR process with the fast convergence function is expressed by Equation (16) below.

$$\begin{matrix}[ Math . 16 ] & \\ Improvement effect [ dB ] = 20 \times {log}_{10} ( \frac{1}{\sqrt{{( \frac{1}{4} )}^{2} + ( {( \frac{1}{3} )}^{2} + ( {( \frac{1}{2} )}^{2} + {( \frac{1}{2} )}^{2} ) \times {( \frac{2}{3} )}^{2} ) \times {( \frac{3}{4} )}^{2}}} ) \approx 6.02 [ dB ] & ( 16 )\end{matrix}$$

Accordingly, in a case of t=0 to 31, the SNR improvement effect produced by the recursive 2DNR process with the fast convergence function is determined as depicted in FIG. 6.

FIG. 7 is a diagram illustrating an SNR improvement effect comparison between the recursive 2DNR process with the fast convergence function and the recursive 2DNR process without the fast convergence function.

The maximum SNR improvement effect produced in a pseudo manner by the recursive 2DNR process capable of combining up 32 lines is theoretically approximately 15.05 [dB]. As depicted in FIG. 7, in the recursive 2DNR process with the fast convergence function, the SNR improvement effect converges at t=31. Meanwhile, in the recursive 2DNR process without the fast convergence function, the SNR improvement effect does not converge.

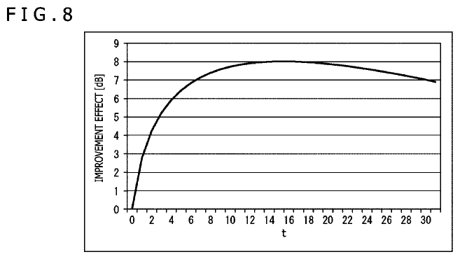

FIG. 8 is a diagram illustrating an example of the SNR improvement effect that is produced by the recursive 2DNR process with the fast convergence function as compared with the recursive 2DNR process without the fast convergence function.

In FIG. 8, the horizontal axis represents t, and the vertical axis represents the SNR improvement effect.

As depicted in FIG. 8, in a case of t=15, the maximum SNR improvement effect produced by the fast convergence function is approximately 18 [dB]. Further, in a case of t=1, the SNR improvement effect produced by the fast convergence function is approximately 2.74 [dB]. Furthermore, in a case of t=4 or later, the SNR improvement effect produced steadily by the fast convergence function is 6 [dB] or more.

As described above, the recursive 2DNR process with the fast convergence function is able to produce a greater SNR improvement effect than the recursive 2DNR process without the fast convergence function.

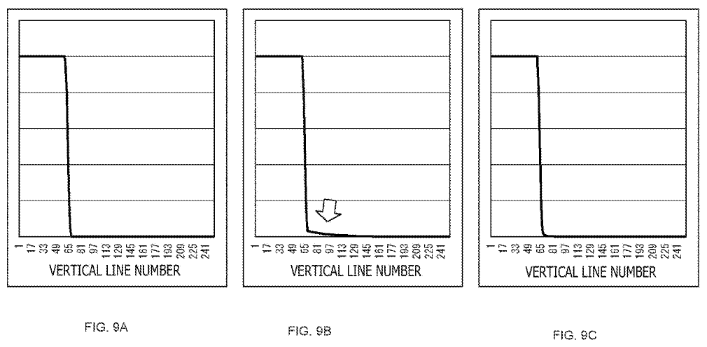

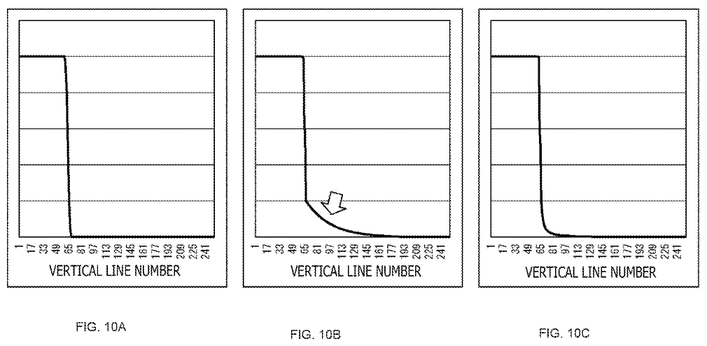

Response characteristics of the recursive 2DNR process without the fast convergence function and recursive 2DNR process with the fast convergence function will now be described with reference to FIGS. 9 and 10. In FIGS. 9 and 10, the horizontal axis represents t, and the vertical axis represents the pixel value.

FIG. 9 is a diagram illustrating the response characteristics in a situation where the strength of NR processing is low.

A of FIG. 9 indicates an input value representing the pixel value of an input image. The input image is an image that contains a vertically oriented edge near line 65.

B of FIG. 9 indicates the response characteristics of the recursive 2DNR process without the fast convergence function. As pointed out by a white arrow in B of FIG. 9, in the recursive 2DNR process without the fast convergence function, a trailing phenomenon occurs so as to drag upper line pixels.

C of FIG. 9 indicates the response characteristics of the recursive 2DNR process with the fast convergence function according to the present technology. As indicated by C of FIG. 9, in the recursive 2DNR process with the fast convergence function, the trailing phenomenon hardly occurs as compared with the recursive 2DNR process without the fast convergence function (B of FIG. 9).

FIG. 10 is a diagram illustrating the response characteristics in a situation where the strength of NR processing is high.

A of FIG. 10 indicates an input value representing the pixel value of an input image. The input image is an image that contains a vertically oriented edge near line 65.

B of FIG. 10 indicates the response characteristics of the recursive 2DNR process without the fast convergence function. In the recursive 2DNR process without the fast convergence function, the trailing phenomenon becomes more intense with an increase in NR strength as pointed out by a white arrow in B of FIG. 10.

C of FIG. 10 indicates the response characteristics of the recursive 2DNR process with the fast convergence function according to the present technology. As indicated by C of FIG. 10, in the recursive 2DNR process with the fast convergence function, the trailing phenomenon hardly occurs as compared with the recursive 2DNR process without the fast convergence function (B of FIG. 10) even in a case where NR strength is high.

As described above, when compared with the recursive 2DNR process without the fast convergence function, the recursive 2DNR process with the fast convergence function is able to reduce the number of lines exhibiting a processing result representative of transient characteristics prevailing before the influence of SNR reaches a steady state no matter whether NR strength is low or high.

More specifically, in a case where the recursive 2DNR process without the fast convergence function is performed on an image depicting a building, the image outputted as the noise reduction result may look as if a building window is on the point of disappearing (an edge of the window is stretched downward) due to the trailing phenomenon. Meanwhile, in a case where the recursive 2DNR process with the fast convergence function is performed on an image depicting a building, the image outputted as the noise reduction result indicates that the trailing phenomenon is suppressed (an edge of the window remains intact).

Further, in a case where, for example, the recursive 2DNR process without the fast convergence function is performed on an image depicting an object in front of a sky, the image outputted as the noise reduction result may look as if the sky is overhanging the object (an edge of the object is stretched downward) due to the trailing phenomenon. Meanwhile, in a case where the recursive 2DNR process with the fast convergence function is performed on an image depicting an object in front of a sky, the image outputted as the noise reduction result indicates that the trailing phenomenon is suppressed (an edge of the object remains intact).

As described above, by performing the recursive 2DNR process with the fast convergence function, the in-vehicle camera system 1 is able to successively suppress a vertical trailing phenomenon in an image obtained as the noise reduction result while keeping the noise reduction effect produced by NR processing.

Accordingly, the in-vehicle camera system 1 is able to effectively reduce noise. Particularly, the in-vehicle camera system 1 is able to reduce white noise at an optimal SNR.

By using limited hardware resources, the in-vehicle camera system 1 is able to achieve SNR improvement performance comparable to a case where 2DNR processing is performed by using a large-capacity line buffer. Therefore, the in-vehicle camera system 1 is able to capture a high-quality video image.

Further, by using limited hardware resources, the in-vehicle camera system 1 is able to achieve SNR improvement performance comparable to a case where 3DNR processing is performed by using a large-capacity frame buffer. Therefore, the in-vehicle camera system 1 is able to capture a high-quality video image.

In a case where the maximum feedback rate is equivalent to the feedback rate in 3DNR processing, the in-vehicle camera system 1 is able to achieve SNR improvement performance comparable to that of 3DNR processing by using a line buffer having a capacity smaller than 3DNR processing requiring the use of a large-capacity frame buffer.

In a case where NR strength is raised excessively high, the trailing phenomenon and other artifacts may occur in the recursive 2DNR process without the fast convergence function. Therefore, NR processing cannot be performed with NR strength raised high. However, the recursive 2DNR process with the fast convergence function according to the present technology is able to perform NR processing with NR strength raised high.

An in-vehicle camera moves when an automobile moves. Therefore, 3DNR processing, which is strong NR processing, is not suitable for NR processing of images captured by the in-vehicle camera. Consequently, 2DNR processing is performed as NR processing of images captured by the in-vehicle camera. However, since the convergence of 2DNR processing is slow, the trailing phenomenon and other artifacts may occur and cause the recognizer 16 to make an erroneous recognition.

The recursive 2DNR process with the fast convergence function according to the present technology is able to suppress the occurrence of artifacts. Therefore, the in-vehicle camera system 1 can be applied to an in-vehicle camera in order to improve the SNR of images acquired by the in-vehicle camera.

In a case where NR processing is performed in an autonomous or advanced driving system, real-time capability is important. Therefore, a circuit scale and simple processing suitable for incorporation into an image sensor are demanded. The in-vehicle camera system 1, which does not require a large-capacity line buffer or frame buffer, is applicable to an autonomous or advanced driving system. Further, since the recursive 2DNR process with the fast convergence function achieves better SNR improvement than the recursive 2DNR process without the fast convergence function, the in-vehicle camera system 1 exerts a favorable influence on the results of detection by the recognizer 16 and DMS.

It should be noted that the in-vehicle camera system 1 produces a strong NR effect by using limited hardware resources and is thus applicable to a surveillance camera. Moreover, the in-vehicle camera system 1 is suitable for applications where a camera significantly moves and is thus applicable to an action camera.

### 4. Modification of Image Processing Section

In some cases, the same pattern appears repeatedly in certain images. In such cases, edges exist repeatedly in a periodic manner. Therefore, when one of a plurality of pixels forming an image is viewed vertically, the count to be stored in the line buffer section 44 is repeatedly constant to some extent.

Accordingly, in a case where the same pattern is repeated in images, the maximum count may be limited in order to prevent strong NR processing from being inadvertently performed.

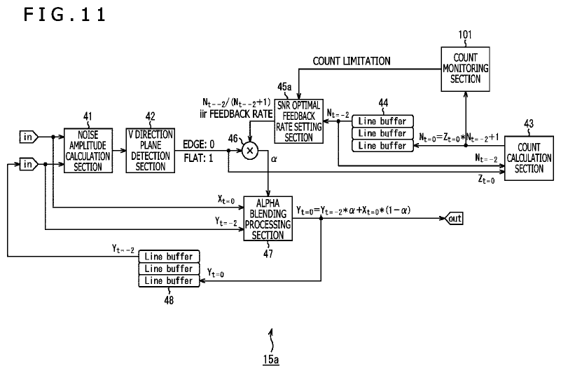

FIG. 11 is a diagram illustrating an example functional configuration of an image processing section 15a.

The configuration of the image processing section 15a depicted in FIG. 11 differs from the configuration of the image processing section 15 described with reference to FIG. 2 in that the former includes a count monitoring section 101 disposed at a stage subsequent to the count calculation section 43. The count Nₜ₌₀ of each of a plurality of pixels included in the current line is supplied from the count calculation section 43 to the count monitoring section 101.

The count monitoring section 101 monitors the count Nₜ₌₀ of each of the plurality of pixels included in the current line that is supplied from the line buffer section 44. In a case where the count Nₜ₌₀ of each of the plurality of pixels included in the current line is repeatedly equal to or smaller than a predetermined threshold, the count monitoring section 101 controls an SNR optimal feedback rate setting section 45a by limiting the maximum count used that is used to set the iir feedback rate for each pixel in the current line.

According to control provided by the count monitoring section 101, the SNR optimal feedback rate setting section 45a sets the iir feedback rate for each of the plurality of pixels included in the current line on the basis of the count Nₜ₌₋₂ of each pixel in the second preceding line, which is acquired from the line buffer section 44, and supplies information indicative of the iir feedback rate to the multiplication section 46.

As described above, in a case where the count of a plurality of processed pixels positioned vertically with respect to a certain pixel in the current line is repeatedly equal to or smaller than a constant value to some extent, the image processing section 15a causes the count monitoring section 101 to limit the maximum count. For example, if the count is inadvertently equal to or greater than a period between edges regardless periodical existence of the edges in a case where the count is repeatedly equal to or smaller than a constant value to some extent, that is, in a case where NR processing is performed on an image whose edges exist repeatedly in a periodic manner, it is assumed that strong NR processing may be erroneously performed.

Consequently, the image processing section 15a causes the count monitoring section 101 to limit the maximum count, and thus enables the SNR optimal feedback rate setting section 45a to set the iir feedback rate by using a count that is equal to or less than the limited maximum count. This prevents strong NR processing from being erroneously performed.

It should be noted that the flow of processing executed by the image processing section 15a is basically similar to the flow of processing depicted in the flowcharts of FIGS. 3 and 4.

As described above, the image processing section 15a causes the count monitoring section 101 to limit the iir feedback rate. This can suppress the occurrence of artifacts and thus can reduce noise.

### 5. Other Modifications

### Example Applications

Some components of the in-vehicle camera system 1 including the image processing section 15 may be disposed, for example, in a television receiver, a broadcast wave transmitter, or a recorder.

### Example Computer Configuration

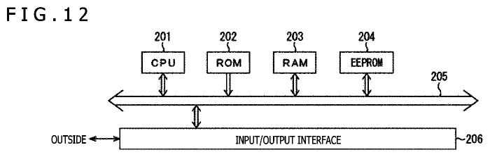

FIG. 12 is a block diagram illustrating an example hardware configuration of a computer that performs the above-described series of processes by executing a program.

In the computer, a CPU (Central Processing Unit) 201, a ROM (Read Only Memory) 202, a RAM (Random Access Memory) 203, and an EEPROM (Electronically Erasable and Programmable Read Only Memory) 204 are interconnected with a bus 205. The bus 205 is further connected to an input/output interface 206. The input/output interface 206 is connected to the outside.

The computer configured as described above performs the above-described series of processes by allowing the CPU 201 to load the program which is stored, for example, in the ROM 202 or the EEPROM 204, into the RAM 203 through the bus 205 and execute the loaded program. Further, the program to be executed by the computer (CPU 201) may be written in advance in the ROM 202 or may be installed in the EEPROM 204 from the outside through the input/output interface 206 or updated.

### Example Applications to Mobile Bodies

The technology according to the present disclosure (the present technology) is applicable to various products. The technology according to the present disclosure may be implemented as a device that is to be mounted in one of various types of mobile bodies such as automobiles, electric automobiles, hybrid electric automobiles, motorcycles, bicycles, personal mobility devices, airplanes, drones, ships, and robots, for example.

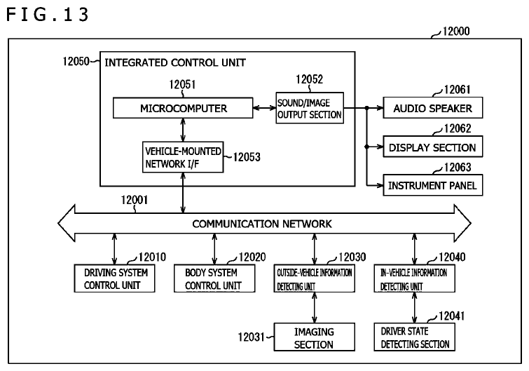

FIG. 13 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 13, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 13, an audio speaker 12061, a display section 12062, and an instrument panel 12063 are illustrated as the output device. The display section 12062 may, for example, include at least one of an on-board display and a head-up display.

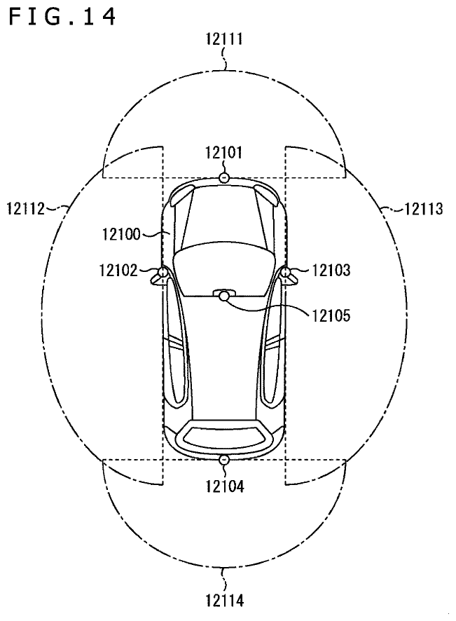

FIG. 14 is a diagram depicting an example of the installation position of the imaging section 12031.

In FIG. 14, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 14 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described above. The technology according to the present disclosure can be applied to the imaging section 12031, the outside-vehicle information detecting unit 12030, the microcomputer 12051, the sound/image output section 12052, and the display section 12062, which are included in the above-described configuration. More specifically, the camera control section 11, the imaging element 12, the analog front-end 13, the A/D conversion section 14, and the image processing section 15, which are depicted in FIG. 1, can be applied to the imaging section 12031. Further, the recognizer 16, which is depicted in FIG. 1, can be applied to the outside-vehicle information detecting unit 12030. The AD/ADAS control section 17, which is depicted in FIG. 1, can be applied to the microcomputer 12051. The sound/image output section 12052 is equivalent to the D/A conversion section 19, which is depicted in FIG. 1. The display section 12062 is equivalent to the display section 20, which is depicted in FIG. 1. When applied to automobiles, the technology according to the present disclosure is able to suppress the occurrence of artifacts and thus obtain images whose noise is reduced. Consequently, the technology according to the present disclosure ensures that outside-vehicle information for use in the ADAS is detected more accurately.

### Miscellaneous

The term “system” used in this description denotes an aggregate of a plurality of components (e.g., devices and modules (parts)), and is applicable no matter whether all the components are within the same housing. Therefore, the term “system” denotes not only a plurality of devices accommodated in separate housings and connected through a network, but also a single device including a plurality of modules accommodated in a single housing.

Advantages described in this description are merely illustrative and not restrictive. The present technology may additionally provide advantages other than those described in this description.

The embodiment of the present technology is not limited to the above-described one, and may be variously modified without departing from the scope and spirit of the present technology.

For example, the present technology may be configured for cloud computing in which one function is shared by a plurality of devices through a network in order to perform processing in a collaborative manner.

Further, each step described with reference to the foregoing flowcharts may be not only performed by a single device but also performed in a shared manner by a plurality of devices.

Moreover, in a case where a plurality of processes is included in a single step, the plurality of processes included in the single step may be not only performed by a single device but also performed in a shared manner by a plurality of devices.

### Example Combinations of Configurations

The present technology can adopt the following configurations.

(1)

An image processing device including:

a feedback rate setting section that sets a feedback rate for pixels in a current line on the basis of a count that is set for pixels in a previous line, the current line and the previous line being among a plurality of lines forming an image, the pixels in the current line being to be subjected to a blending process of blending inputted pixels in the current line and already outputted pixels in the previous line;

a blending section that blends the pixels in the current line and the pixels in the previous line in accordance with the feedback rate; and

a calculation section that calculates a count that is indicative of a cumulative number of pixels blended with the pixels in the current line by the blending process and is to be set for the pixels in the current line.

(2)

The image processing device according to (1), further including:

an edge detection section that detects an edge of pixels in the current line,

in which, on the basis of a detection result indicating the result of detection of an edge of pixels in the current line, the calculation section calculates a count that is to be set for the pixels in the current line.

(3)

The image processing device according to (2),

in which the edge detection section sets the detection result to 0 in a case where an edge of the pixels in the current line is detected, and sets the detection result to 1 in a case where no edge of the pixels in the current line is detected, and in which the calculation section calculates a count that is to be set for the pixels in the current line by multiplying the count set for the pixels in the previous line by the detection result and adding 1 to a result of the multiplication.

(4)

The image processing device according to (3), further including:

a multiplication section that calculates a ratio of blending the pixels in the previous line by multiplying the feedback rate by the detection result,

in which the blending section blends the pixels in the current line with the pixels in the previous line at the ratio.

(5)

The image processing device according to any one of (1) to (4),

in which the feedback rate setting section adds 1 to the count set for the pixels in the previous line, divides the count set for the pixels in the previous line by a result of the addition, and sets a result of the division as the feedback rate.

(6)

The image processing device according to any one of (1) to (5), further including:

a monitoring section that monitors a count set for each pixel, and limits the count set for the pixels in the previous line on the basis of a result of the monitoring,

in which the feedback rate setting section sets the feedback rate on the basis of the count limited by the monitoring section.

(7)

The image processing device according to (6),

in which, in a case where the count is repeatedly equal to or smaller than a threshold, the monitoring section limits a maximum count that is set for the pixels in the previous line and is to be used for setting the feedback rate.

(8)

The image processing device according to (1), including:

a sensor chip,

in which the sensor chip includes
an imaging element that acquires a signal representing the image,
an analog front-end that performs an analog process on the signal,
a conversion section that converts the analog-processed signal to digital image data,
an image processing section that includes the feedback rate setting section, the blending section, and the calculation section, and
a control section that controls the imaging element, the analog front-end, the conversion section, and the image processing section.
   (9)

An image processing method for causing an image processing device to perform the steps of:

setting a feedback rate for pixels in a current line on the basis of a count that is set for pixels in a previous line, the current line and the previous line being among a plurality of lines forming an image, the pixels in the current line being to be subjected to a blending process of blending inputted pixels in the current line and already outputted pixels in the previous line;

blending the pixels in the current line and the pixels in the previous line in accordance with the feedback rate; and

calculating a count that is indicative of a cumulative number of pixels blended with the pixels in the current line by the blending process and is to be set for the pixels in the current line.

(10)

A program for causing a computer to perform the processes of:

setting a feedback rate for pixels in a current line on the basis of a count that is set for pixels in a previous line, the current line and the previous line being among a plurality of lines forming an image, the pixels in the current line being to be subjected to a blending process of blending inputted pixels in the current line and already outputted pixels in the previous line;

blending the pixels in the current line and the pixels in the previous line in accordance with the feedback rate; and

calculating a count that is indicative of a cumulative number of pixels blended with the pixels in the current line by the blending process and is to be set for the pixels in the current line.

### REFERENCE SIGNS LIST

1: In-vehicle camera system
11: Camera control section
12: Imaging element
13: Analog front-end
14: A/D conversion section
15: Image processing section
16: Recognizer
17: AD/ADAS control section
18: Storage
19: D/A conversion section
20: Display section
41: Noise amplitude calculation section
42: V direction plane detection section
43: Count calculation section
44: Line buffer section
45: SNR optimal feedback rate setting section
46: Multiplication section
47: Alpha blending processing section
48: Line buffer section
101: Count monitoring section

1. An image processing device comprising:
a feedback rate setting section that sets a feedback rate for pixels in a current line on a basis of a count that is set for pixels in a previous line, the current line and the previous line being among a plurality of lines forming an image, the pixels in the current line being to be subjected to a blending process of blending inputted pixels in the current line and already outputted pixels in the previous line;
a blending section that blends the pixels in the current line and the pixels in the previous line in accordance with the feedback rate; and
a calculation section that calculates a count that is indicative of a cumulative number of pixels blended with the pixels in the current line by the blending process and is to be set for the pixels in the current line.

2. The image processing device according to claim 1, further comprising:
an edge detection section that detects an edge of pixels in the current line,
wherein, on a basis of a detection result indicating the result of detection of an edge of pixels in the current line, the calculation section calculates a count that is to be set for the pixels in the current line.

3. The image processing device according to claim 2,
wherein the edge detection section sets the detection result to 0 in a case where an edge of the pixels in the current line is detected, and sets the detection result to 1 in a case where no edge of the pixels in the current line is detected, and
wherein the calculation section calculates a count that is to be set for the pixels in the current line by multiplying the count set for the pixels in the previous line by the detection result and adding 1 to a result of the multiplication.

4. The image processing device according to claim 3, further comprising:
a multiplication section that calculates a ratio of blending the pixels in the previous line by multiplying the feedback rate by the detection result,
wherein the blending section blends the pixels in the current line with the pixels in the previous line at the ratio.

5. The image processing device according to claim 1,
wherein the feedback rate setting section adds 1 to the count set for the pixels in the previous line, divides the count set for the pixels in the previous line by a result of the addition, and sets a result of the division as the feedback rate.

6. The image processing device according to claim 1, further comprising:
a monitoring section that monitors a count set for each pixel, and limits the count set for the pixels in the previous line on a basis of a result of the monitoring,
wherein the feedback rate setting section sets the feedback rate on a basis of the count limited by the monitoring section.

7. The image processing device according to claim 6,
wherein, in a case where the count is repeatedly equal to or smaller than a threshold, the monitoring section limits a maximum count that is set for the pixels in the previous line and is to be used for setting the feedback rate.

8. The image processing device according to claim 1, comprising:
a sensor chip,
wherein the sensor chip includes
an imaging element that acquires a signal representing the image,
an analog front-end that performs an analog process on the signal,
a conversion section that converts the analog-processed signal to digital image data,
an image processing section that includes the feedback rate setting section, the blending section, and the calculation section, and
a control section that controls the imaging element, the analog front-end, the conversion section, and the image processing section.

9. An image processing method for causing an image processing device to perform the steps of:
setting a feedback rate for pixels in a current line on a basis of a count that is set for pixels in a previous line, the current line and the previous line being among a plurality of lines forming an image, the pixels in the current line being to be subjected to a blending process of blending inputted pixels in the current line and already outputted pixels in the previous line;
blending the pixels in the current line and the pixels in the previous line in accordance with the feedback rate; and
calculating a count that is indicative of a cumulative number of pixels blended with the pixels in the current line by the blending process and is to be set for the pixels in the current line.

10. A program for causing a computer to perform the processes of:
setting a feedback rate for pixels in a current line on a basis of a count that is set for pixels in a previous line, the current line and the previous line being among a plurality of lines forming an image, the pixels in the current line being to be subjected to a blending process of blending inputted pixels in the current line and already outputted pixels in the previous line;
blending the pixels in the current line and the pixels in the previous line in accordance with the feedback rate; and
calculating a count that is indicative of a cumulative number of pixels blended with the pixels in the current line by the blending process and is to be set for the pixels in the current line.
